(19) United States
(12) Patent Application Publication
(10) Pub. No.: US 2001/0052434 A1
(43) Pub. Date: Dec. 20, 2001

(54) Proximity sensing system and trailer including same

(76) Inventors: Donald J. Ehrlich, Lafayette, IN (US); James B. Brown JR., Lafayette, IN (US)

Correspondence Address: TREXLER, BUSHNELL, GIANGIORGI,, BLACKSTONE & MARR, LTD., 105 W. ADAMS STREET, CHICAGO, IL, 60603, US

(21) Appl. No.: 09/755,291

(22) Filed: Jan. 5, 2001

Related U.S. Application Data
(60) Provisional application No. 60/175,431, filed on Jan. 11, 2000.

(51) Int. Cl. B62D 1/24

(52) U.S. Cl. 180/169; 180/271

(57) ABSTRACT

A proximity sensing system for a trailer which includes at least one non-contact proximity sensor which is in communication with a brake system. The brake system is configured to operate depending on what is sensed by the proximity sensor. The proximity sensing system may be in communication with electronics and a feedback device in the trailer, such as a display device and/or a speaker. The electronics is configured to control the feedback device depending on what is sensed by the proximity sensor. Preferably, a tractor includes an engine and an electronic engine controller in operable association with the engine. The proximity sensor is in communication with the electronic engine controller, and the electronic engine controller is configured to operate the engine depending on what is sensed by the proximity sensor. The proximity sensor may be optical, microwave or ultrasonic technology based, or may be some other suitable sensor.

### BACKGROUND OF THE INVENTION

This invention is generally directed to a novel proximity sensing system. As will be described, the proximity sensing system may be provided on a trailer.

In the trucking industry, loads are stored in trailers, and trailers are connected to tractors which are driven by truck drivers. In a tractor/trailer combination, the tractor and trailer are connected not only mechanically, but also electrically. Such a connection allows, among other things, operation of a braking system on the trailer in response to application of the brakes. A typical trailer includes air brakes as well as an anti-lock brake system (ABS) for controlling the air brakes. Conventional ABS's include an Electronic Control Module (ECM), a Pneumatic Control Module (PCM) and wheel speed sensors. The various components may be known by different names, for example the ECM is sometimes called the Electronic Brake Control Unit or Electronic Control Unit(ECU). The PCM may be known as a modulator. Some ABS implementations integrate the PCM into another component known as the relay valve.

The wheel speed sensors provide wheel speed information to the ECM and the ECM signals the PCM to modify air pressure level at the brake chambers. This whole process controls the braking level so that the wheels continue to rotate, or at least rotate most of the time, even during heavy braking. The general configuration and operation of ABS systems are well known in the art.

Typically, when a truck driver arrives at a dock, the truck driver backs the trailer until the trailer contacts the dock. Thereafter, a load can be loaded into or unloaded from the trailer, perhaps by using a fork lift. In order to prevent damaging the trailer or the dock, it is advantageous for the truck driver to back the trailer slowly and to stop backing the trailer immediately upon the trailer contacting the dock. Unfortunately, a typical tractor/trailer combination provides no means for alerting the truck driver as to the distance which remains between the back of the trailer and the dock, or for alerting the truck driver that the trailer has contacted, or is about to contact, the dock. Additionally, a typical tractor/trailer combination provides no means for preventing the truck driver from inadvertently smashing the trailer into the dock while backing up.

The present invention provides a novel proximity sensing system which can be employed in association with a trailer. As will be described, such a system can make it easier for a truck driver to back a trailer to a dock, as well as reduce the likelihood that the trailer, dock become damaged. Other features and advantages will become apparent upon a reading of the attached specification, in combination with a study of the drawings.

### OBJECTS AND SUMMARY OF THE INVENTION

Accordingly, it is an object of an embodiment of the present invention to provide a proximity sensing system for use with a trailer.

Another object of an embodiment of the present invention is to provide a proximity sensing system which provides sensory feedback, such as an audio and/or visual indication, with regard to that which is sensed.

Still another object of an embodiment of the present invention is to provide a proximity sensing system which is in communication with a brake system.

Still yet another object of an embodiment of the present invention is to provide a proximity sensing system which is in communication with an electronic engine controller.

Briefly, and in accordance with one or more of the foregoing objects, an embodiment of the present invention provides a proximity sensing system which can be employed on a trailer. The proximity sensing system includes at least one non-contact proximity sensor which is in communication with a brake system, and the brake system is configured to operate depending on what is sensed by the proximity sensor. Preferably, the sensor is disposed proximate a rear portion of the trailer.

Preferably, the trailer includes a wiring harness which is configured for electrical connection to corresponding wiring on a tractor. Preferably, the tractor includes electronics and a feedback device, such as a display and/or a speaker. The proximity sensor is in communication with the electronics, and the electronics is configured to control the feedback device depending on what is sensed by the proximity sensor. Preferably, the tractor also includes an engine and an electronic engine controller in operable association with the engine, and the proximity sensor is in communication with the electronic engine controller. Preferably, the electronic engine controller is configured to operate the engine depending on what is sensed by the proximity sensor. The proximity sensor may be optical, microwave or ultrasonic technology based, or may be some other suitable sensor.

### BRIEF DESCRIPTION OF THE DRAWINGS

The organization and manner of the structure and function of the invention, together with further objects and advantages thereof, may be understood by reference to the following description taken in connection with the accompanying drawings, wherein:

FIG. 1 is a rear perspective view of a truck, more specifically a trailer engaged with a tractor, showing proximity sensors mounted on the rear of the trailer;

FIG. 2 is a block diagram of a proximity sensing system which may be employed in the truck illustrated in FIG. 1, where the proximity sensing system is configured to provide feedback to the driver, and the feedback depends on what is sensed by the proximity sensors;

FIG. 3 is a block diagram of a proximity sensing system which may be employed in the truck illustrated in FIG. 1, where the proximity sensing system includes a brake system on the trailer, where the brake system is configured to operate depending on what is sensed by the proximity sensors;

FIG. 4 is a block diagram of a proximity sensing system similar to that which is shown in FIG. 3, but where the proximity sensing system includes a brake application unit which is generally separate from a brake system on the trailer;

FIG. 5 is a block diagram of a proximity sensing system which may be employed in the truck illustrated in FIG. 1, where the proximity sensing system is configured to control an engine of the tractor depending on what is sensed by the proximity sensors on the trailer; and

FIG. 6 is a block diagram of a proximity sensing system which may be employed in the truck illustrated in FIG. 1, where the proximity sensing system is configured to provide feedback to the driver of the tractor, apply brakes of the trailer, and control the engine of the tractor, all depending on what is sensed by the proximity sensors on the trailer.

### DETAILED DESCRIPTION OF ILLUSTRATED EMBODIMENTS

While the present invention may be susceptible to embodiment in different forms, there are shown in the drawings, and herein will be described in detail, embodiments of the invention with the understanding that the present description is to be considered an exemplification of the principles of the invention and is not intended to limit the invention to that as illustrated and described herein.

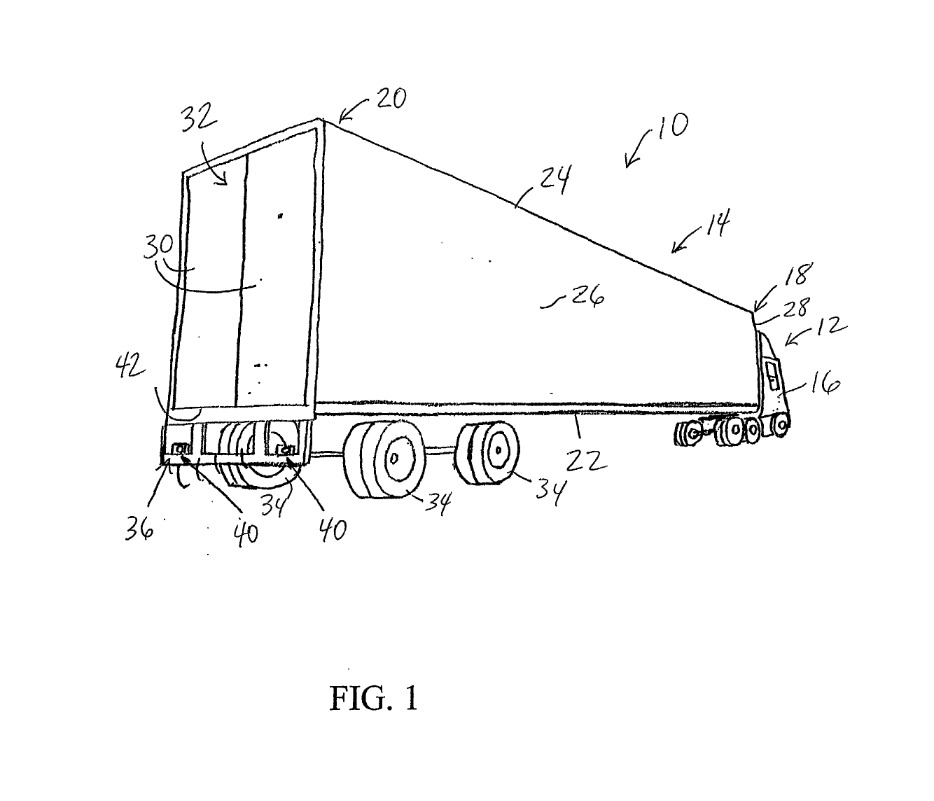

FIG. 1 illustrates a truck 10 consisting of a tractor 12 and a trailer 14 which is engaged with the tractor 12. The tractor 12 includes an engine and a cab 16 in which a truck driver sits to drive the truck 10. The trailer 14 is engaged mechanically with the tractor 12, as well as electrically via one or more wiring harnesses. The trailer 14 includes a front portion 18 and a rear portion 20, as well as a floor 22, a roof 24, side walls 26 (only one shown), a front wall 28, and doors 30 which, when closed as shown in FIG. 1, define a rear wall 32. Wheels 34 and a guard 36 are disposed at the rear portion 20 of the trailer 14.

Proximity sensors 40 are provided on the rear portion 20 of the trailer 14. Specifically, as shown, preferably the proximity sensors 40 are provided on the guard 36, at a point which is lower than a bottom 42 of the doors 30. This location ensures that the proximity sensors 40 can effectively sense a loading dock because a loading dock usually provides a surface under the dock doors and the surface is typically lower than the bottom of the doors of a trailer. While FIG. 1 depicts the proximity sensors 40 disposed on the guard 36 of the trailer 14, the proximity sensors 40 may be located elsewhere on the trailer 14 or on the tractor 12. Additionally, while FIG. 1 depicts two proximity sensors 40, a single sensor or more than two sensors may be provided. The proximity sensors 40 may be any type of non-contact sensor which can measure the distance to objects close to the rear of the trailer 14. For example, the proximity sensors 40 may be based on optical, microwave or ultrasonic technology. If a microwave or ultrasonic sensor is used, a wave pulse is emitted by the sensor, reflects off the object being sensed and returns to the sensor. The round trip time is then used by the electronics to calculate the distance to the object.

Regardless of how many proximity sensors 40 are provided, or where on the trailer 14 or tractor 12 the one or more proximity sensors 40 are disposed, the proximity sensors 40 are preferably employed in a proximity sensing system which provides that a loading dock can be detected or sensed. Specifically, the proximity sensors 40 detect a loading dock and generally assist the driver in backing the trailer 14 to a dock. As will be described, depending on the system, the assistance which is provided to the driver may be audio and/or visual feedback to the driver, automatic braking of the trailer wheels 34 and/or automatic control of the engine of the tractor 12.

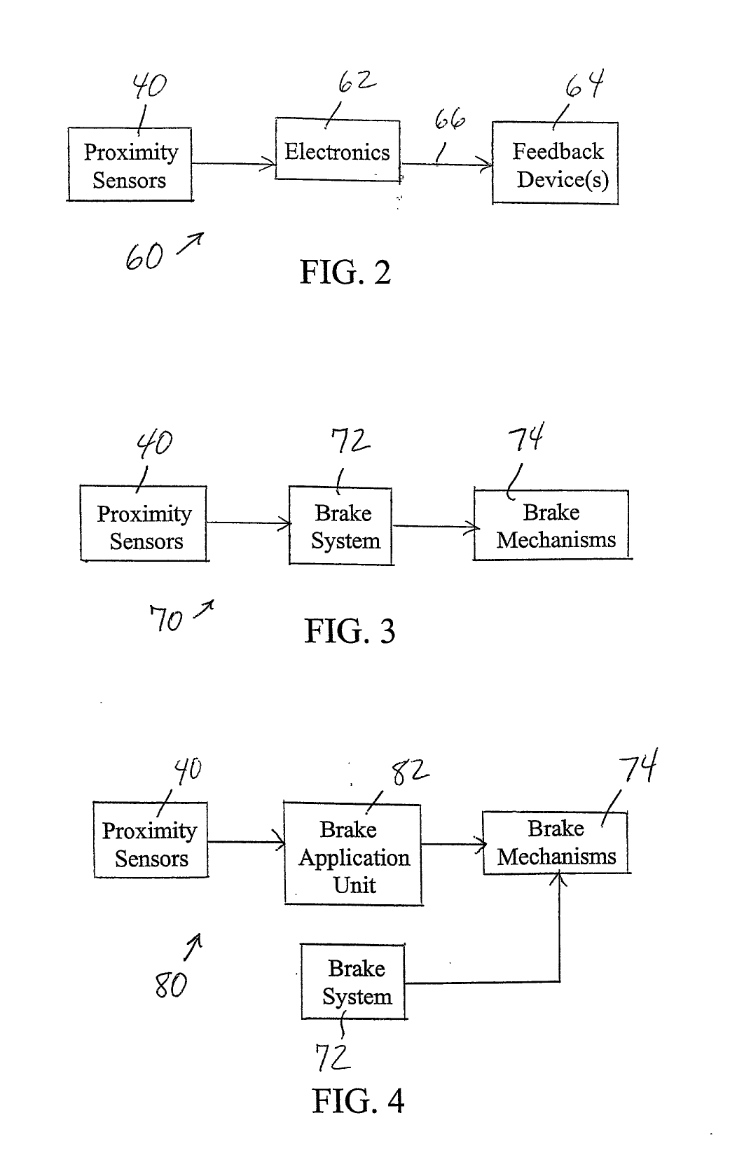

FIG. 2 illustrates a system 60 which provides that feedback is given to the driver. The driver can then consider the feedback while backing the trailer 14 to a loading dock. As shown in FIG. 2, the system 60 provides that the proximity sensors 40 are in communication with electronics 62, and that the electronics 62 are operably connected to one or more feedback devices 64. The electronics 62 may be located on the tractor 12 or the trailer 14. For example, the electronics 62 may be part of the ECM of an anti-lock brake system (ABS) on the trailer 14 or may be part of an electropnuematic brake system (EBS) on the trailer 14. The exact location or form of the electronics 62 is not imperative. Preferably, the feedback device 64 comprises one or more speakers and/or one or more display devices which are disposed in the cab 16 of the tractor 12 (see FIG. 1).

If the feedback device 64 consists of a speaker, preferably the electronics 62 is configured to use the speaker to produce a warning sound indicating to the driver that the trailer 14 has contacted, or is in close proximity to, the loading dock. In other words, preferably the electronics 62 is configured to operate the one or more speakers depending on what is sensed by the proximity sensors 40.

On the other hand, if the feedback device 64 consists of a display device, preferably the electronics 62 is configured to operate the display device to produce a display indicating to the driver that the trailer 14 has contacted, or is in close proximity to, the loading dock. In other words, preferably the electronics 62 is configured to operate the display device depending on what is sensed by the proximity sensors 40. The display device may provide a readout to the driver of the distance to the loading dock.

Of course, if the feedback device 64 consists of both a speaker and display device, preferably the electronics 62 is configured to operate both the speaker and display device depending on what is sensed by the proximity sensors 40.

As described above, the trailer 14 is electrically connected to the tractor 12 via one or more wiring harnesses. If the electronics 62 is provided on the trailer 14, preferably the electronics 62 is in communication with one or more wiring harnesses of the trailer 14, and is configured to provide a signal to the tractor 12 through the wiring harness(es), depending on what is sensed by the proximity sensors 40. As such, in FIG. 2, the arrow 66 showing a connection between the electronics 62 and feedback device(s) 64 may consist of a wiring harness connection, such as a PLC4TRUCKS (SAE J2497) connection.

FIG. 3 illustrates a system 70 which provides that the brake system 72 of the trailer 14 is controlled based on what is sensed by the proximity sensors 40. As shown, the system 70 provides that the proximity sensors 40 are in communication with the brake system 72 of the trailer, and the brake system 72 is operably connected to brake mechanisms 74 of the trailer 14. The brake system 72 may consist of, for example, an ABS or EBS and may provide forward and/or reverse wheel speed sensing as disclosed in U.S. Provisional Application Ser. No. 60/171,741, filed Dec. 22, 1999, which is hereby incorporated in its entirety be reference. Regardless of the type of brake system provided, preferably the brake system 72 is configured such that the brake mechanisms 74 are actuated depending on what is sensed by the proximity sensors 40. Specifically, preferably the system 70 provides if the truck 10 (see FIG. 1) approaches the loading dock too rapidly, the brake mechanisms 74 are actuated as the trailer 14 gets closer and closer to the dock, thereby applying brakes to the wheels 34 of the trailer 14. As such, the system 70 assists the driver in backing the trailer 14 to the dock, and ensures that the trailer 14 does not smash into the dock damaging either the dock or the trailer 14. The brake system 72 may be configured such that the brakes are applied such that the overall speed of the trailer 14 is not allowed to exceed a predetermined threshold while backing up, and as the rear of the trailer 14 comes in close proximity to the dock, the allowed speed is reduced to a very low rate.

The system 70 which is illustrated in FIG. 3 may be provided as a supplement to the system 60 which is illustrated in FIG. 2. In this case, the system would not only apply the brakes of the trailer 14 while the driver is backing the trailer 14 to the loading dock, but would also provide feedback to the driver (i.e. audio and/or visual feedback) while the driver is backing the trailer 14.

The system 80 illustrated in FIG. 4 is very similar to that which is shown in FIG. 3, except the system in FIG. 4 provides that the proximity sensors 40 are in communication with a brake application unit 82 which is generally separate from the brake system 72 of the trailer. While the brake system 72 provides for control of the brake mechanisms 74 during normal operation of the trailer 14, the brake application unit 82 provides for control of the brake mechanisms 74 while the trailer 14 is being backed to a dock. Preferably, the brake application unit 82 is configured to actuate the brake mechanisms 74 depending on what is sensed by the proximity sensors 40. Specifically, preferably the system 80 provides if the truck 10 (see FIG. 1) approaches the loading dock too rapidly, the brake application unit 82 actuates the brake mechanisms 74 as the trailer 14 gets closer and closer to the dock. As such, the system 80 assists the driver in backing the trailer 14 to the dock, and ensures that the trailer 14 does not smash into the dock damaging either the dock or the trailer 14.

Much like the system 70 which is illustrated in FIG. 3, the system 70 which is illustrated in FIG. 4 may also be provided as a supplement to the system 60 which is illustrated in FIG. 2 in which case the system would control the brakes of the trailer 14 as well as provide feedback to the driver while the driver is backing the trailer 14 to the loading dock.

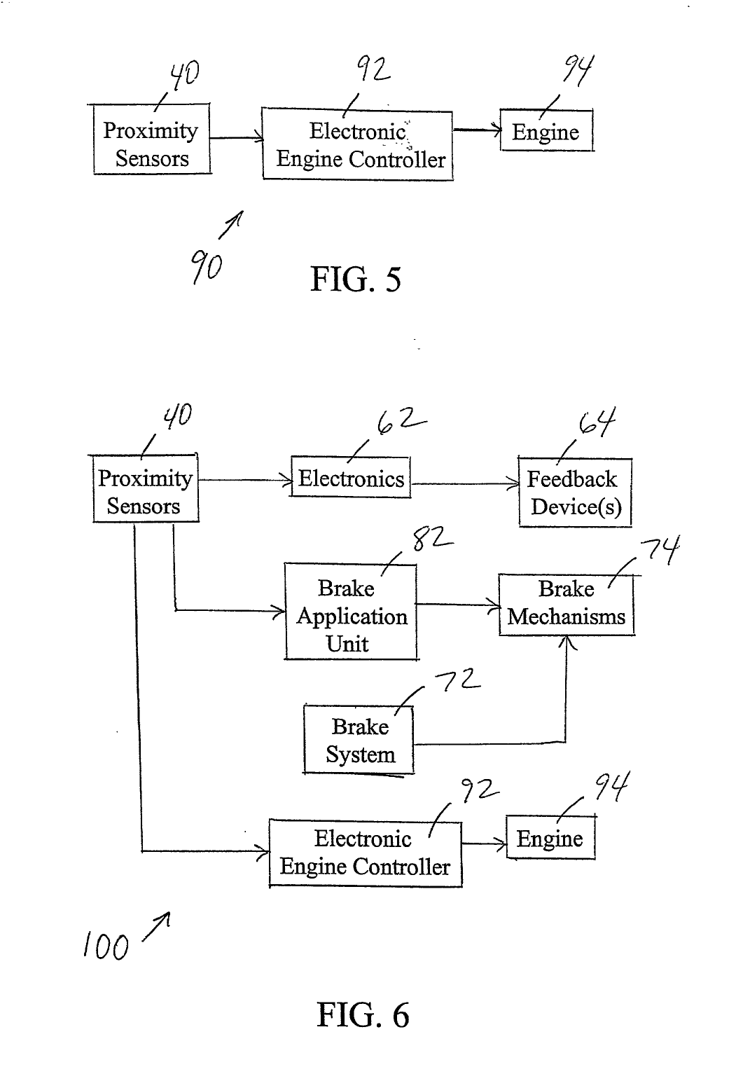

The system 90 illustrated in FIG. 5 provides that the engine 94 of the tractor 12 is controlled based on what is sensed by the proximity sensors 40. The system 90 provides that the proximity sensors 40 are in communication with an electronic engine controller 92 of the tractor 12, and the electronic engine controller 92 is operably connected to the engine 94. The electronic engine controller 92 is configured to control the engine 94 of the tractor 12 (while the trailer 14 is being backed to a loading dock) depending on what is sensed by the proximity sensors 40. Preferably, the engine 94 is controlled such that the driver is assisted in backing the trailer 14, and damage to the trailer 14 and the dock is avoided.

The system 90 which is illustrated in FIG. 5 may be provided as a supplement to any one of the systems 60, 70, 80 which are illustrated in FIGS. 2-4, in which case the system would provide feedback to the driver and/or would control the brakes of the trailer 14 as well as control the engine 94 of the tractor 12 while the driver is backing the trailer 14 to the loading dock. For example, FIG. 6 illustrates a system 100 which provides all three back up assistance mechanisms (feedback, brake control and engine control). As shown, the system 100 is effectively a combination of the systems of FIGS. 2, 4 and 5.

Regardless of which system is used, preferably a proximity sensing system is provided which assists the driver in backing a trailer 14 to a loading dock. As such, the driver can efficiently perform the maneuver, while avoiding damaging the dock and trailer 14.

While the proximity sensors 40 have been described in relation for usage in detecting a dock, it is to be understood that other objects can be detected using the proximity sensors 40. In addition, the proximity sensors 40 could be modified for use on the tractor 12 or other vehicles.

While embodiments of the present invention are shown and described, it is envisioned that those skilled in the art may devise various modifications without departing from the spirit and scope of the foregoing description.

The invention claimed is:

1. A proximity sensing system comprising: at least one proximity sensor; a brake system, said at least one proximity sensor in communication with said brake system, said brake system configured to operate depending on what is sensed by said at least one proximity sensor.

2. A proximity sensing system as recited in claim 1, further comprising an engine; an electronic engine controller in operable association with said engine, said at least one proximity sensor in communication with said electronic engine controller, said electronic engine controller configured to operate said engine depending on what is sensed by said at least one proximity sensor.

3. A proximity sensing system as recited in claim 1, further comprising a feedback device and electronics in operable communication with said feedback device, said at least one proximity sensor in communication with said electronics, said electronics configured to operate said feedback device depending on what is sensed by said at least one proximity sensor.

4. A proximity sensing system as recited in claim 3, wherein said feedback device comprises at least one of a display device and a speaker.

5. A proximity sensing system as recited in claim 1, wherein said at least one proximity sensor comprises at least one of an optical sensor, a microwave technology based sensor and an ultrasonic technology based sensor.

6. A proximity sensing system comprising: at least one proximity sensor; a feedback device; electronics in operable communication with said feedback device; a brake system; an engine; an electronic engine controller in operable association with said engine, said at least one proximity sensor in communication with said electronics, said brake system, and said electronic engine controller, said electronics configured to operate said feedback device depending on what is sensed by said at least one proximity sensor, said brake system configured to operate depending on what is sensed by said at least one proximity sensor, and said electronic engine controller configured to operate said engine depending on what is sensed by said at least one proximity sensor.

7. A trailer comprising: at least one proximity sensor; a brake system, said at least one proximity sensor in communication with said brake system, said brake system configured to operate depending on what is sensed by said at least one proximity sensor.

8. A trailer as recited in claim 7, said trailer including a rear portion, said at least one proximity sensor disposed proximate said rear portion.

9. A trailer as recited in claim 8, wherein said at least one proximity sensor comprises at least one of an optical sensor, a microwave technology based sensor and an ultrasonic technology based sensor.

10. A trailer comprising: electronics; at least one proximity sensor in communication with said electronics; and a wiring harness configured for electrical connection to corresponding wiring, said electronics in communication with said wiring harness and configured to provide a signal thereto depending on what is sensed by said at least one proximity sensor.

11. A trailer as recited in claim 10, further comprising a brake system, said at least one proximity sensor in communication with said brake system, said brake system configured to operate depending on what is sensed by said at least one proximity sensor.

12. A trailer as recited in claim 10, wherein said at least one proximity sensor comprises at least one of an optical sensor, a microwave technology based sensor and an ultrasonic technology based sensor.

13. A truck comprising: a tractor; and a trailer engaged with said tractor, said trailer including at least one proximity sensor, said truck including electronics, said at least one proximity sensor in communication with said electronics, said truck including a feedback device, said electronics in communication with said feedback device and configured to control said feedback device depending on what is sensed by said at least one proximity sensor.

14. A truck as recited in claim 13, said trailer further comprising a brake system, said at least one proximity sensor in communication with said brake system, said brake system configured to operate depending on what is sensed by said at least one proximity sensor.

15. A truck as recited in claim 13, said tractor including an engine and an electronic engine controller in operable association with said engine, said at least one proximity sensor in communication with said electronic engine controller, said electronic engine controller configured to operate said engine depending on what is sensed by said at least one proximity sensor.

16. A truck as recited in claim 13, said tractor including an engine and an electronic engine controller in operable association with said engine, said trailer including a brake system, said at least one proximity sensor in communication with said brake system and said electronic engine controller, said brake system configured to operate depending on what is sensed by said at least one proximity sensor, and said electronic engine controller configured to operate said engine depending on what is sensed by said at least one proximity sensor.

17. A truck as recited in claim 13, wherein said feedback device comprises at least one of a display device and a speaker in said tractor.

18. A truck as recited in claim 13, wherein said at least one proximity sensor comprises at least one of an optical sensor, a microwave technology based sensor and an ultrasonic technology based sensor.

19. A truck comprising: a tractor; and a trailer engaged with said tractor, said trailer including at least one proximity sensor, said tractor including an engine and an electronic engine controller in operable association with said engine, said at least one proximity sensor in communication with said electronic engine controller, said electronic engine controller configured to operate said engine depending on what is sensed by said at least one proximity sensor.
